(19) United States
(12) Patent Application Publication
(10) Pub. No.: US 2026/0028213 A1
(43) Pub. Date: Jan. 29, 2026

(54) LOAD HANDLING DEVICE

(71) Applicant: Ocado Innovation Limited, Hatfield (GB)

(72) Inventors: Jake Collins, Waltham, MA (US); Kurt Bilis, Waltham, MA (US); Callum Gow, Waltham, MA (US); Daniel Grieneisen, Waltham, MA (US); Daryl van Kampen, Waltham, MA (US)

(21) Appl. No.: 18/785,563

(22) Filed: Jul. 26, 2024

(51) Int. Cl. B66F 9/075; B66F 9/14; B66F 9/24

(52) U.S. Cl. CPC B66F 9/0755; B66F 9/144; B66F 9/24

(57) ABSTRACT

A robotic vehicle is provided which can detect the type of a platform, such as a pallet. The robotic vehicle may comprise forks which can be inserted into the platform. The forks of the robotic vehicle comprise at least one sensor arrangement. The sensor arrangement(s) can detect the size and location of the platform elements as the forks are inserted into the platform, enabling the platform type to be determined. The operation of the vehicle can then be controlled in accordance with the platform type.

The disclosure relates to a load handling device, and in particular to an autonomous vehicle which can lift move pallets, for example within a storage facility.

### BACKGROUND

A robotic vehicle (e.g., a robotic truck) can include forks (also referred to as tynes or tines) to enable the vehicle to pick up and move object(s) (e.g., a pallet) in an environment such as a warehouse.

A platform such as a pallet may be used in a warehouse to support goods and to enable the goods to be carried from one location to another while on the platform. The platform includes opening(s) or slot(s) to facilitate lifting of the platform by a vehicle such as a forklift truck. Platforms can vary in size, shape, weight, form factor, etc. The variance in the size and design of a platform can cause problems with the lifting and movement of such platforms.

### SUMMARY

According to a first aspect of the present disclosure, there is provided a robotic vehicle comprising: a body, the body comprising a platform support area; a drive means configured, in use, to move the robotic vehicle; a first fork and a second fork, the first and second forks being received within the body, the first fork comprising one or more sensors and the second fork comprising one or more sensors; wherein in use the robotic vehicle is configured to; move the robotic vehicle into a position in proximity to a platform; extend the first and second forks to protrude from the body of the robotic vehicle; insert at least a portion of the first and second forks into the interior of the platform; in accordance with the data received from the one or more sensors of the first fork and/or the one or more sensors of the second fork, determine the location and/or size of one or more platform elements; and identify the type of platform in accordance with the determination of the one or more platform elements.

In use, the first and second forks may be moved to a pre-determined position within the platform in accordance with the identified platform type. The first and second forks may be raised to lift the platform when the first and second forks are moved to the pre-determined position within the platform.

Each of the first and second forks may comprise a first sensor arrangement configured to look outward. Each of the first and second forks may comprise a second sensor arrangement configured to look downward. Each of the first and second forks may comprise a third sensor arrangement configured to look inward at the opposed fork. Each of the first and second forks may comprise a further sensor arrangement arranged to look upward.

The robotic vehicle may further comprise drive means configured to move the robotic vehicle and processor circuitry to control the drive means. The robotic vehicle may further comprise lifting control circuitry configured to raise the first and second forks to lift the platform.

A robotic vehicle according to the present disclosure is able to identify the type of platform based on the data received from the sensor(s) present in the fork(s). Once the type of platform has been identified then the robotic vehicle may use the information when lifting the platform. For example, the robotic vehicle may advance the forks to an identified lifting position for the type of platform identified. The speed at which the forks are advanced to the identified lifting position may be increased. The maximum weight of a loaded platform may be used to determine the speed at which the forks are raised, and/or the lifting force that is applied through the forks. This enables a platform to be lifted in a more controlled and repeatable manner.

According to a second aspect of the present disclosure, there is provided a computer-implemented method for controlling the operation of a robotic vehicle, the method comprising: moving the robotic vehicle into a position in proximity to a platform; extending a first fork and a second fork of the robotic vehicle to protrude from the body of the robotic vehicle; inserting at least a portion of the first and second forks into the interior of the platform; determining the location and/or size of one or more platform elements in accordance with the data received from the one or more sensors of the first fork and/or the one or more sensors of the second fork; and identifying the type of platform in accordance with the determination of the one or more platform elements.

According to a third aspect of the present disclosure, there is provided a non-transitory computer-readable medium having instructions stored thereon that cause at least one processor circuit to at least: cause a robotic vehicle to move into a position in proximity to a platform; extend a first fork and a second fork of the robotic vehicle to protrude from the body of the robotic vehicle; insert at least a portion of the first and second forks into the interior of the platform; determine the location and/or size of one or more platform elements in accordance with the data received from the one or more sensors of the first fork and/or the one or more sensors of the second fork; and identify the type of platform in accordance with the determination of the one or more platform elements.

### BRIEF DESCRIPTION OF THE DRAWINGS

Embodiments of the invention will now be described by way of example only with reference to the accompanying drawings, in which like reference numbers designate the same or corresponding parts, and in which:

FIGS. 1 and 2 show schematic depictions of a robotic vehicle according to an example of the present disclosure;

FIGS. 3a & 3b show a schematic depiction of the first fork and the second fork;

FIGS. 4a & 4b show a schematic depiction of an alternative arrangement of the first fork and the second fork;

FIG. 5 shows a schematic depiction of a flowchart in which a robotic vehicle receives an instruction (step S501), for example from a warehouse management system, to move to a pre-determined location in a storage environment;

FIG. 6 shows a schematic depiction of further aspects of the robotic vehicle; and

FIG. 7 shows a schematic depiction of a computer device which may be comprised within the robotic vehicle.

### DETAILED DESCRIPTION

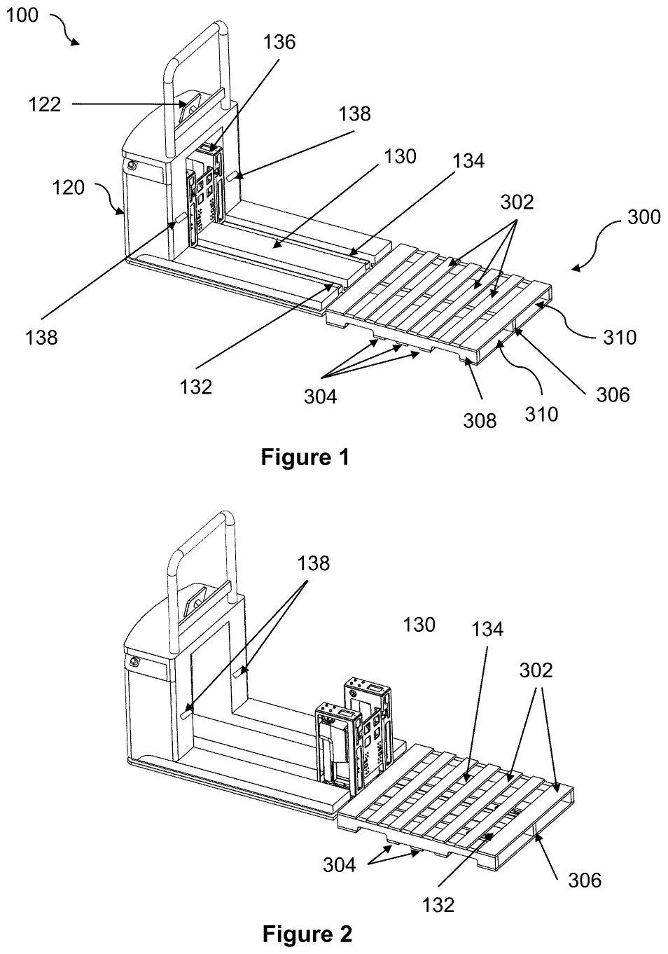

FIG. 1 shows a schematic depiction of a robotic vehicle 100 according to an example of the present disclosure. The robotic vehicle 100 comprises a body 120 in which are housed multiple components used in the operation of the vehicle, for example control electronics, a drive module which can be controlled by the control electronics to control the movement of the robotic vehicle and other actions of the robotic vehicle. The robotic vehicle further comprises a platform support area 130 which is located at the rear of the robotic vehicle. The robotic vehicle further comprises a lifting shuttle 136 which is coupled to a first fork 132 and second fork 134. In operation, the lifting shuttle can be advanced from the body of the robotic vehicle, such that the first fork 132 and the second fork 134 are advanced from underneath the platform support area 130. The first fork and the second fork may be inserted into the interior of a platform (for example a pallet) such that that the platform may be lifted from the surface in which it is resting (for example the floor) to a height which is above that of the platform support area 130. The robotic vehicle may then advance such that the platform can be lowered onto the platform support area 130 and such that the lifting shuttle 136 is received within the body of the robotic vehicle. An example of such a robotic vehicle is disclosed in the Applicant's co-pending international patent application PCT/EP2024/064402.

FIG. 2 shows a schematic depiction of a robotic vehicle 100 according to an example of the present disclosure when the lifting shuttle 136 has been advanced from the body of the robotic vehicle such that the such that the first fork 132 and the second fork 134 are received within the interior of a platform 300, in this case a pallet.

The pallet 300 shown in FIGS. 1 & 2 comprises a plurality of upper deck boards 302 on which a load may be received. The pallet also comprises a plurality of lower deck boards 304 which are in contact with the ground (or the surface upon which the pallet is resting). The upper deck boards 302 and the lower deck boards 304 are connected by a number of stringers, in this example two external stringers 308, which are located at the edge of the pallet, and one internal stringer 306. The combination of the upper deck boards, lower deck boards and the stringers define apertures 310 on opposed faces of the pallet into which the forks of a robotic vehicle can be inserted. The pallet described above with reference to FIGS. 1 and 2 is known as a stringer pallet.

In an alternative arrangement, the pallet may be a type of pallet known as a block pallet, in which the stringers are replaced with a number of blocks that connect the upper deck boards to the lower deck boards. Typically, a block pallet comprises nine blocks, with one block being received at substantially the same position as the ends and the midpoint of each of the three stringers shown in FIGS. 1 and 2. Some types of pallets do not comprise lower deck boards such that the pallet rests on the floor on the stringers (or a combination of stringers and/or blocks).

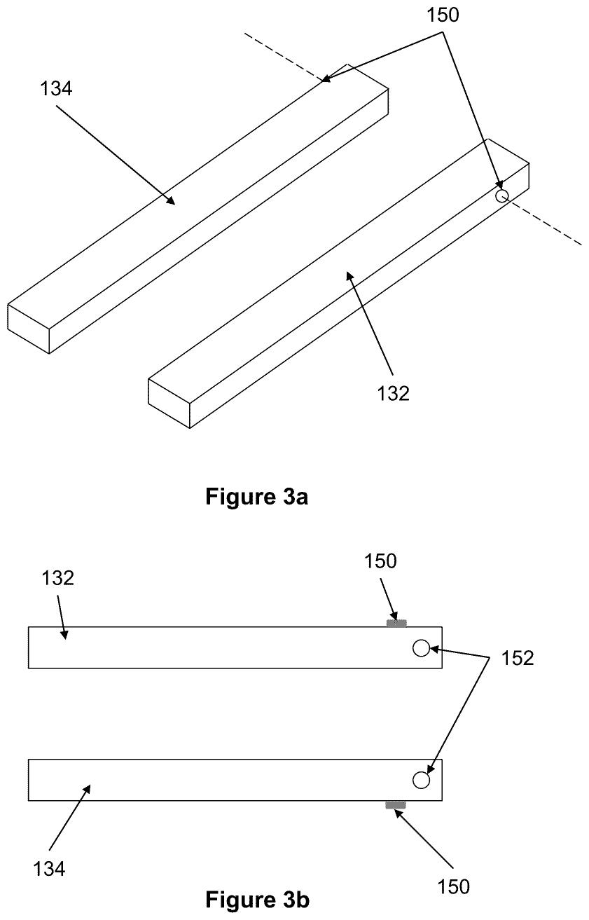

FIG. 3a shows a schematic depiction of the first fork 132 and the second fork 134. The first fork 132 and the second fork 134 comprise a first sensor arrangement 150. The first sensor arrangement 150 is located near to the distal ends of the first and second forks and is arranged on the interior faces of the first and second forks. The first sensor arrangement 150 is activated as the first and second forks are inserted into the apertures 310 of a pallet. The presence of a stringer (or a block, in accordance with the structure of the pallet) will be detected by the first sensor arrangement 150. The first sensor arrangement may, in one example, comprise a first transceiver received on the exterior face of one of the first or second forks and a second transceiver received on the exterior face of the other fork. The transceiver(s) may be optical transceivers, ultrasonic transceivers, or another suitable alternative. It can be seen that the insertion of the first and second forks of the robotic vehicle into a pallet will cause the level of the signal received at a transceiver to vary in accordance with the presence or the absence of a pallet stringer (or pallet block). If a transmitter or transceiver generates a signal that may be reflected by a pallet stringer (or pallet block) then the presence (or absence) of a pallet stringer (or pallet block) may be detected based on changes in the time of flight of a reflected signal rather than a change in signal strength.

FIG. 3b shows a schematic depiction of the underside of the first fork 132 and the second fork 134 as shown in FIG. 3a. The first fork 132 and the second fork 134 may further comprise a second sensor arrangement 152. The second sensor arrangement 152 is located near to the distal ends of the first and second forks and is arranged on the lower faces of the first and second forks such that the second sensor arrangement 152 is facing the floor upon which the robotic vehicle operates. The second sensor arrangement 152 is activated as the first and second forks are inserted into the apertures 310 of a pallet. The presence of a lower deck board 304 will be detected by the second sensor arrangement 152. In one example, the second sensor arrangement 152 comprises two transceivers which generate a signal and then detect the signal that is reflected back from a surface. For example, the reflected signal will vary as the second sensor arrangement 152 moves from a first position where the second sensor arrangement is above the floor to a second position where the second sensor arrangement is above a lower deck board of a pallet to a third position where the second sensor arrangement is above the floor. The transceivers of the second sensor arrangement may comprise optical transceivers, ultrasonic transceivers, or another suitable alternative. The transceivers of the second sensor arrangement may determine the presence (or absence) of a lower deck board of a pallet based on variations in the detected signal strength, time of flight measurements, a combination of the two (and/or further metric(s)).

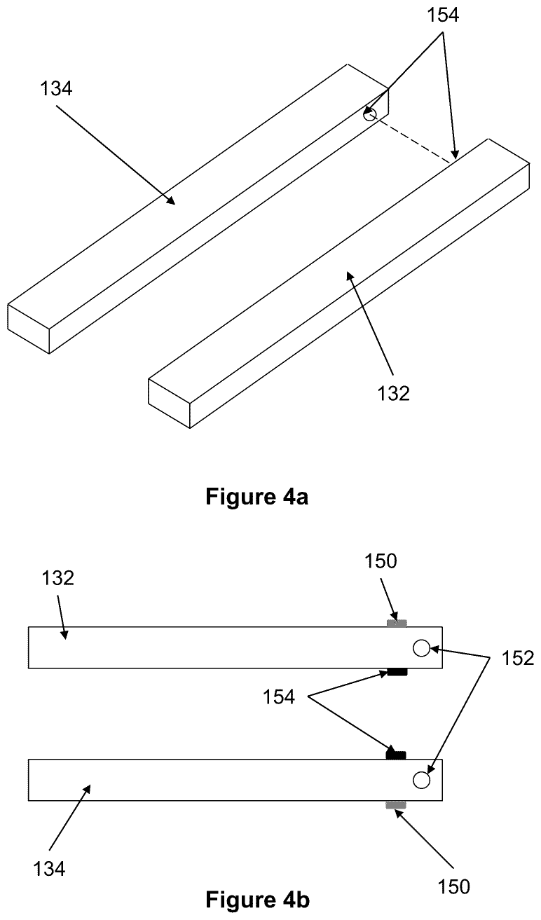

FIG. 4a shows an alternative arrangement of the first fork 132 and the second fork 134 discussed above with reference to FIG. 3a, in which the first sensor arrangement 150 is replaced with a third sensor arrangement 154. The third sensor arrangement 154 is located near to the distal ends of the first and second forks and is arranged on the interior faces of the first and second forks. The third sensor arrangement 154 is activated as the first and second forks are inserted into the apertures 310 of a pallet. The presence of a stringer (or a block, in accordance with the structure of the pallet) will be detected by the third sensor arrangement 154. The third sensor arrangement may, in one example, comprise a transmitter received on the interior face of one of the first or second forks and an appropriate receiver received on the interior face of the other fork. It will be understood that when a pallet stringer (or pallet block) is present in between the transmitter and the receiver that the signal received at the receiver will be greatly attenuated compared to the signal that is received when there is no pallet stringer (or pallet block) is present in between the transmitter and the receiver. In such an example, it will be understood that the transmitter may transmit an optical signal (which may comprise a visible wavelength, infra-red or other wavelength), an ultrasonic signal or other suitable alternative.

In an alternative example, the third sensor arrangement may comprise a transceiver received on the interior face of one of the first or second forks and a reflector element received on the interior face of the other fork. In a yet further alternative, the third sensor arrangement may comprise a first transceiver received on the interior face of one of the first or second forks and a second transceiver received on the interior face of the other fork. Again, the transceiver(s) may be optical transceivers, ultrasonic transceivers, or another suitable alternative. It can be seen that the insertion of the first and second forks of the robotic vehicle into a pallet will cause the level of the signal received at a transceiver to vary in accordance with the presence or the absence of a pallet stringer (or pallet block). It should be understood that alternative variations of the third sensor arrangement may be provided. If a transmitter or transceiver generates a signal that may be reflected by a pallet stringer (or pallet block) then the presence (or absence) of a pallet stringer (or pallet block) may be detected based on changes in the time of flight of a reflected signal rather than a change in signal strength.

As an alternative to the arrangement described above with reference to FIG. 4a, the third sensor arrangement 154 may augment the first sensor arrangement 150 such that the insertion of the forks causes both the first and third sensor arrangements to be activated. Thus, pallet elements which are located between the first and second forks will be detected as well as pallet elements which are located on the outside of the forks.

FIG. 4b shows a schematic depiction of the underside of the first fork 132 and the second fork 134 in the case where the first and second forks comprise the first sensor arrangement 150, the second sensor arrangement 152 and the third sensor arrangement 154. It should be understood that one, some or all of the sensor arrangements may be activated when the first and second forks are inserted into the interior of a pallet. The operation of the one or more sensor arrangements may be used to determine the presence of pallet elements such that the type of pallet can be identified.

In an alternative arrangement, the first and second forks may additionally comprise one or more sensor elements arranged to look upward, that is to determine the presence (or absence) of upper deck boards 302. The upward looking sensors may be used to augment the information provided by one or more of the first sensor arrangement, the second sensor arrangement and/or the third sensor arrangement such that the type of pallet can be identified based on the size and location of the pallet elements that are detected.

Referring to FIGS. 1 and 2, the body of the robotic vehicle may comprise a fourth sensor arrangement 138. The fourth sensor arrangement may be arranged such that it can view a platform, such as a pallet, as the platform support area 130 of the robotic vehicle is manoeuvred when approaching a platform. In one example, the fourth sensor arrangement comprises two cameras 138 which are arranged so as to have a view of the platform support area 130 of the robotic vehicle. In use, the cameras can be used to detect the apertures 310 of a pallet (or similar platform), such that the robotic vehicle can be pre-positioned relative to the pallet. The fourth sensor arrangement may also be used by the computer vision systems which are used in the navigation of the robotic vehicle, or they may be separate and only used for the detection of the platform apertures.

If the robotic vehicle is approaching a block pallet, then there will be apertures on each of the four faces of the block pallet. In such a case, the robotic vehicle may detect the apertures on the nearest face of the block pallet and, if there are no obstructions, the robotic vehicle may move to a position adjacent to the block pallet such that the robotic vehicle is able to insert the first and second forks into the interior of the block pallet. If obstructions (for example, another robotic vehicle, human operators, other pallets, boxes, etc.) are present then the robotic vehicle can determine which of the other faces of the block pallet are unobstructed. The robotic vehicle may then move to a position adjacent to an unobstructed face of the block pallet such that the robotic vehicle is able to insert the first and second forks into the interior of the block pallet.

If the robotic vehicle is approaching a stringer pallet, then it will be understood that the stringer pallet only comprises apertures 310 on two opposed faces of the stringer pallet. In such a case, the robotic vehicle will attempt to detect if the nearest face of the stringer pallet comprises apertures. If it does, and there are no obstructions, then the robotic vehicle may move to a position adjacent to that face of the stringer pallet such that the robotic vehicle is able to insert the first and second forks into the interior of the block pallet. If the nearest face of the stringer pallet does not comprise any apertures, i.e. it comprises one of the side stringers 308, then the robotic vehicle can infer which two sides of the stringer pallet comprise the apertures and can navigate to a position adjacent to one of those sides, such that the robotic vehicle is able to insert the first and second forks into the interior of the block pallet.

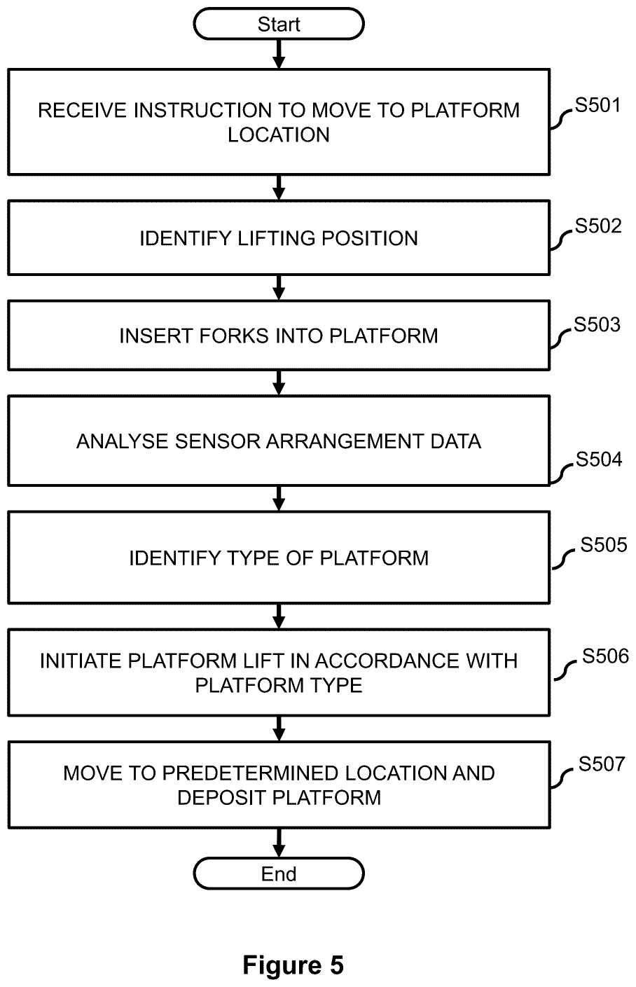

FIG. 5 shows a schematic depiction of a flowchart in which a robotic vehicle receives an instruction (step S501), for example from a warehouse management system, to move to a pre-determined location in a storage environment (such as a customer fulfilment centre, a warehouse or similar enterprise) where a platform (for example, a pallet) is stored. For example, the platform may be at a dock having been off-loaded from a delivery vehicle (or similar) and now needs to be moved to a temporary storage, to be moved for induction into an automated storage and retrieval system, or for some other purpose etc. The robotic vehicle will navigate through the storage environment to the location specified in the instruction. The robotic vehicle will determine an appropriate lifting position adjacent to the platform (S502), for example using the fourth sensor arrangement to determine the location of platform apertures and any obstacles near to the platform and move to it, such that the robotic vehicle is positioned such that it can insert the forks into the platform. If more than one appropriate lifting position is identified, then the robotic vehicle will select one of them and will then move into that position.

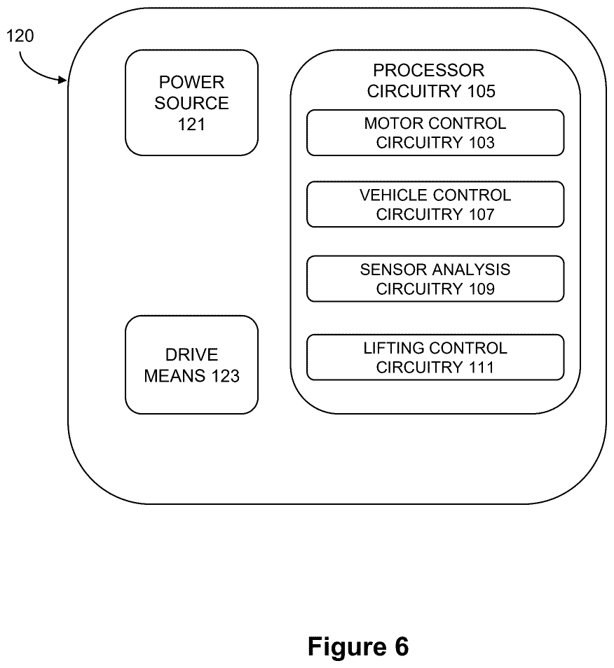

The robotic vehicle will then insert the first and second forks into the interior of the platform, via the platform apertures. The insertion of the forks causes the sensor arrangements received within the forks (that is, one or more of the first sensor arrangement 150, the second sensor arrangement 152 and/or the third sensor arrangement 154) to activate. The data received from the one or more sensor arrangements 152 is processed by sensor analysis circuitry 109 (referring to FIG. 6). The sensor data can be analysed to determine if the first sensor arrangement or the third sensor arrangement has detected the presence of a stringer (or a block). The sensor data can be further analysed to determine if the second sensor arrangement has detected the presence of a lower deck board. The absence or presence of such features can be logged, for example as digital values, and stored alongside a measure of the distance that the forks have been advanced into the platform. The sensor data can be refreshed on a periodic basis, for example at regular time intervals or when the forks have been advanced by a pre-determined distance. For example, the sensor data may be refreshed each time the forks are advanced by 1 mm.

It has been observed that due to the different dimensions of pallets which are commonly used in the storage and transportation industries, it is possible to identify a platform (S505) from the profile of the presence (or absence) of a stringer and a lower deck board as the first and second forks are advanced into the platform. For example, the sensor analysis circuitry 109 may comprise a look-up table holding data for the different platforms which are present in the storage environment. The look-up table may be updated as and when platforms of different types are inducted into the storage environment.

Once the type of platform has been identified then the robotic vehicle is able to infer lifting parameters for use with the platform. For example, a Euro-1 pallet has an area of 800 mm×1200 mm whilst a Euro-2 pallet has an area of 1000 mm×1200 mm. Once the platform has been identified then the forks can be inserted such that they support the entire width (or length) of the pallet without the forks extending beyond the width (or length) of the platform. This enables the platform to be lifted safely and effectively. Once the platform has been identified and an optimal fork insertion length has been determined then the speed at which the forks are inserted may be increased.

Once the forks have been inserted to an optimal position then the platform can be lifted (S506). The identification of the platform type may be used by the robotic vehicle to determine a lifting profile. For example, a Euro-6 pallet has an area of 800×600 mm and thus the robotic vehicle may apply a lesser lifting force for a Euro-6 pallet than for a Euro-1 pallet or a Euro-2 pallet.

The lifted pallet may then be moved to a further location within the storage environment (see S507) and deposited. For example, it may be moved to a location from which the items stored on the pallet can be unloaded into containers, onto shelving etc, to a storage location for subsequent loading to a vehicle, etc. or an empty pallet may be stacked for subsequent use. Once the pallet has been deposited on the floor (or similar surface) then the robotic vehicle may withdraw the first and second forks from the pallet and return them to the retracted position underneath the platform support area. The robotic vehicle may then be tasked to collect and move a further pallet.

The data received from the one or more sensor arrangements may be used for other purposes. For example, the data received from the first sensor arrangement and/or the second sensor arrangement may indicate that the forks have been inserted such that they are not perpendicular to the direction of the upper deck boards 302. If the orientation of the forks relative to the upper deck boards exceeds a predetermined threshold value, then this may cause the pallet to be received on the forks in an unbalanced manner. In such a case, the drive means (see below with reference to FIG. 6) may be selectively activated in order to reduce the orientation of the forks relative to the upper deck boards. In some cases, this may require the robotic vehicle to withdraw the forks, either partially or entirely, before re-inserting the forks.

FIG. 6 shows a schematic depiction of further aspects of the robotic vehicle that are not described above with reference to FIGS. 1 & 2. The example robotic vehicle 100 comprises a body 120 and a drive means 121 which may comprise one or more motors (e.g. electric motor(s) and/or other drive mechanism(s)) to cause movement of the body 120 via the wheel(s) of the robotic vehicle 100. The robotic vehicle 100 includes motor control circuitry 103 (e.g. hardware and/or software components) to control, for example, the speed of the robotic vehicle 100. One or more components of the motor control circuitry 103 can be implemented by processor circuitry 105 of the vehicle 100.

The robotic vehicle 100 can include an autonomous vehicle. The robotic vehicle 100 includes vehicle control circuitry 107 to control movement of the autonomous or self-driving robotic vehicle 100. One or more components of vehicle control circuitry 107 can be implemented by the processor circuitry 105 of the robotic vehicle 100, processor circuitry of another user device, and/or cloud-based device(s). The robotic vehicle 100 can move to a location in a storage environment without or with limited user input control during movement of the vehicle 100. The lifting control circuitry 111 controls the movement of the forks, for example into and out of the interior of a platform and the vertical movement of the forks to lift or lower the forks (and a platform received on the forks). In an alternative arrangement, the robotic vehicle may take the form of a pump truck. In such an arrangement, the robotic vehicle has a smaller body and does not have a platform support area under which the forks can be retracted. The forks can be inserted into the interior of a pallet (or other platform) and then the movement and actions of the vehicle and the forks can be controlled in accordance with the data generated by the sensor arrangements within the forks.

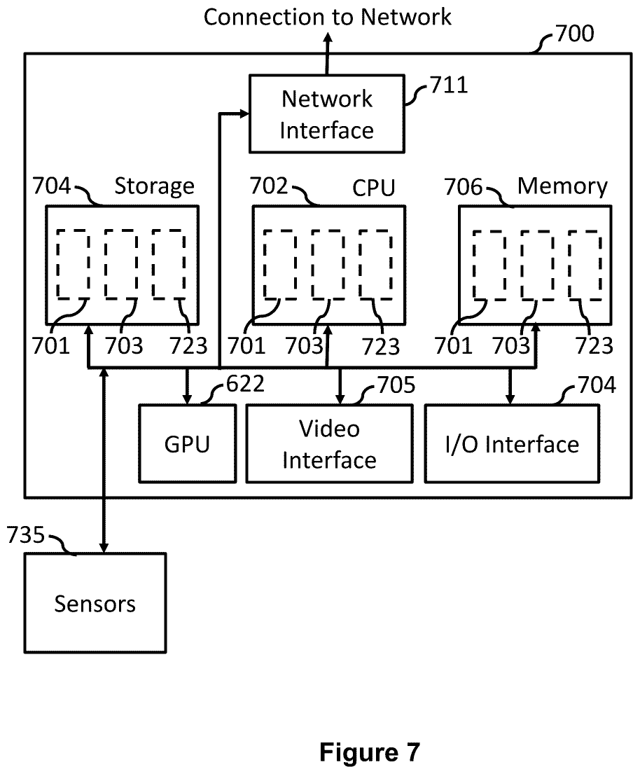

It will be understood that a robotic vehicle according to the present disclosure may comprise one or more computing devices, for example for instantiating the processor circuitry 105. FIG. 7 shows a schematic depiction of a computer device 700 that may include a central processing unit (“CPU”) 702 connected to a storage unit 714 and to a random access memory 706. The CPU 702 may process an operating system 701, application program 703, and data 723. The operating system 701, application program 703, and data 723 may be stored in storage unit 714 and loaded into memory 706, as may be required. Computer device 700 may further include a graphics processing unit (GPU) 722 which is operatively connected to CPU 702 and to memory 706 to offload intensive image processing calculations from CPU 702 and run these calculations in parallel with CPU 702. The computing device may further comprise a network interface 711, for example a Wi-Fi interface or a cellular interface (for example, an interface using LTE technology), to communicate with a warehouse management system and/or other systems operating in the storage environment in which the robotic vehicle operates. The computer device 700 may receive data from one or more sensors 735. These sensors may comprise the first sensor arrangement 150, the second sensor arrangement 152 and the fourth sensor arrangement 138. Data generated by one or more further sensors may also be received by the computer device and used to control the movement and operation of the robotic vehicle.

The foregoing description of embodiments of the disclosure has been presented for the purpose of illustration and description. It is not intended to be exhaustive or to limit the disclosure to the precise form disclosed. Modifications and variations can be made without departing from the spirit and scope of the present disclosure.

According to an aspect, a robotic vehicle is provided which can detect the type of a platform, such as a pallet. The robotic vehicle may comprise forks which can be inserted into the platform. The forks of the robotic vehicle comprise at least one sensor arrangement. The sensor arrangement(s) can detect the size and location of the platform elements as the forks are inserted into the platform, enabling the platform type to be determined. The operation of the vehicle can then be controlled in accordance with the platform type.

1. A robotic vehicle comprising:
a body, the body comprising a platform support area;
a drive means configured, in use, to move the robotic vehicle;
a first fork and a second fork, the first and second forks being received within the body, the first fork comprising one or more sensors and the second fork comprising one or more sensors;
wherein in use the robotic vehicle is configured to;
move the robotic vehicle into a position in proximity to a platform;
extend the first and second forks to protrude from the body of the robotic vehicle;
insert at least a portion of the first and second forks into the interior of the platform;
in accordance with data received from the one or more sensors of the first fork and/or the one or more sensors of the second fork, determine the location and/or size of one or more platform elements; and
identify the type of platform in accordance with the determination of the one or more platform elements.

2. A robotic vehicle according to claim 1, wherein the first and second forks are moved to a pre-determined position within the platform in accordance with the identified platform type.

3. A robotic vehicle according to claim 2, wherein the first and second forks are moved to the pre-determined position within the platform and then the first and second forks are raised to lift the platform.

4. A robotic vehicle according to claim 1, wherein the first and second forks comprise a first sensor arrangement configured to look outward.

5. A robotic vehicle according to claim 1, wherein the first and second forks comprise a second sensor arrangement configured to look downward.

6. A robotic vehicle according to claim 1, wherein the first and second forks comprise a third sensor arrangement configured to look inward at the opposed fork.

7. A robotic vehicle according to claim 1, wherein the first and second forks comprises a further sensor arrangement arranged to look upward.

8. A robotic vehicle according to claim 1, wherein the robotic vehicle body comprises a fourth sensor, the fourth sensor being configured to detect one or more apertures in the face of a platform.

9. A robotic vehicle according to claim 1, wherein the robotic vehicle further comprises drive means configured to move the robotic vehicle and processor circuitry to control the drive means.

10. A robotic vehicle according to claim 1, wherein the robotic vehicle further comprises lifting control circuitry configured to raise the first and second forks to lift the platform.

11. A computer-implemented method for controlling operation of a robotic vehicle, the method comprising:
moving the robotic vehicle into a position in proximity to a platform;
extending a first fork and a second fork of the robotic vehicle to protrude from a body of the robotic vehicle;
inserting at least a portion of the first and second forks into the interior of the platform;
determining the location and/or size of one or more platform elements in accordance with data received from one or more sensors of the first fork and/or the one or more sensors of the second fork; and
identifying the type of platform in accordance with the determination of the one or more platform elements.

12. The method of claim 11, further comprising moving the first and second forks to a pre-determined position within the platform in accordance with the identified platform type.

13. The method of claim 12, further comprising
raising the first and second forks to lift the platform once the first and second forks have moved to the pre-determined position within the platform.

14. The method of claim 11, further comprising
moving the platform to a pre-determined position and lowering the platform such that it is received on a surface.

15. The method of claim 13, further comprising
moving the robotic vehicle to withdraw the first and second forks from the interior of the platform.

16. A non-transitory computer-readable medium having instructions stored thereon that cause at least one processor circuit to at least:
cause a robotic vehicle to move into a position in proximity to a platform;
extend a first fork and a second fork of the robotic vehicle to protrude from a body of the robotic vehicle;
insert at least a portion of the first and second forks into the interior of the platform;
determine the location and/or size of one or more platform elements in accordance with data received from one or more sensors of the first fork and/or the one or more sensors of the second fork; and
identify the type of platform in accordance with the determination of the one or more platform elements.
